(19) United States
(12) Patent Application Publication
(10) Pub. No.: US 2014/0316829 A1
(43) Pub. Date: Oct. 23, 2014

(54) System for Implementing a Travel Network with Trip Planning and Social Media Capabilities

(71) Applicant: William Bumbernick, Mickleton, NJ (US)

(72) Inventor: William Bumbernick, Mickleton, NJ (US)

(21) Appl. No.: 14/256,973

(22) Filed: Apr. 20, 2014

Related U.S. Application Data
(60) Provisional application No. 61/814,230, filed on Apr. 20, 2013.

(51) Int. Cl. G06Q 10/02; G06Q 50/00; G06Q 30/02

(52) U.S. Cl. CPC G06Q 10/025; G06Q 30/0269; G06Q 30/0261; G06Q 50/01
USPC 705/6; 705/14.66; 705/14.58

(57) ABSTRACT

A system and methodology through which users can access various features and functionality relative to travel and collaborative and informational aspects thereof. This functionality is accessed through a website available to users through various devices such as tablets, PCs, laptops, smartphones and other similar devices. The system and methodology provides trip planning features such that users can upload, view and modify content associated with trips taken or planned as well as view trip information of others subject to appropriate authorization. Further, the system of the present invention may include interfaces and interoperability with social media services so that activity occurring through one of these services can be shared with other services and the services of the present invention and vice versa.

### RELATED APPLICATION

This application is related to U.S. Provisional Patent Application Ser. No. 61/814,230 titled “System for Implementing a Travel Network with Trip Planning and Social Media Capabilities” filed on Apr. 20, 2013, the complete subject matter of which is incorporated by reference herein in its entirety.

### FIELD OF THE INVENTION

The present invention relates generally to internet based applications and systems and more particularly to travel based website functionality including dynamic content generation and social media capabilities.

### BACKGROUND OF THE INVENTION

People travel for many reasons. Travel may be undertaken for business purposes, to visit family and friends as well as for recreational or cultural reasons and for many other purposes. As a result of this, the travel and travel related industries have become large and are continually growing.

Services associated with the travel industry lend themselves well to internet based offerings. For example, it is possible to book train, bus, airplane and other transportation services online. In addition, it is possible to book hotel rooms, condos and other accommodations through internet based services. Many other travel related needs can also be obtained through online based businesses. These include tours, car rentals, transportation to and from an airport, tickets to attractions and just about any other item that a traveler needs or desires in connection with his or her trip.

For many kinds of travel but particularly for recreational travel, it is valuable for travelers and for those planning on taking trips to benefit from the knowledge and experience of others. This may include reviews or thoughts on particular places, particular attractions as well as recommendations for things to do and what to see. For example, it is helpful to many individuals as part of their trip planning process to learn what other objective travelers have experienced at restaurants, hotels, attractions, etc. in the past. There exists a number of online websites that are dedicated to providing this information.

Social media, including the many ways of connecting people who share common interests, is very popular these days. There exist a number of extremely popular websites where individuals can connect in real time or practically real time and share news, photos, videos, applications, recipes, and practically anything else that can be uploaded or linked to. In addition, blogging and other related methodologies for individuals to share information and other content with groups of other individuals who may be interested in what is shared, is also very popular. Travel experiences lend themselves well to these methods of distributing and sharing information. For example, there exist a number of blogs specifically dedicated to travel and even more specifically to travel in certain regions or to travel relating to specific interests such as camping, adventure travel, scuba diving, etc.

While a very large number of travel websites exist, they do not generally link social media capabilities with travel related content or otherwise leverage the powerful tools now available for sharing content with groups of others who are likely to be interested in that content. Further, these websites do not generally allow for real time or near real time updates of trips planned or trips in progress in a form which can be viewed by other travelers and potential travelers in a way that provides a robust and interactive user experience.

### SUMMARY OF THE INVENTION

It is thus a primary object of the invention to provide a system and methodology that addresses the shortcomings of the prior art as discussed above.

It is another object of the present invention to provide a system and methodology which implements a social travel network that allows bloggers, adventurers and travellers and others interested in travel or the travel industry to connect with each other based on similar interests.

It is a further object of the present invention to provide a system in which those interested in travel can access and interact with enhanced and robust blogging, logging and other interactive capabilities.

It is a still further object of the present invention to allow users of the system to create, modify, access and share trip itineraries based on actual or planned trips or both.

It is an even further object of the present invention to provide a number of automated services and features associated with trips taken or planned by users including the sharing of trips in a format that is easily viewed and very usable by others.

It is another object of the present invention to provide a system which allows users to display and view travel itineraries and content relative to trips being taken or which have been completed in a timeline format such that content is presented chronologically.

It is a further object of the present invention to provide a system which offers a number of additional unique and novel features such as the enablement of interactivity between and among users with respect to planned and taken trips including real time location tracking and the enablement of communication and discussion with respect to various locations and travel sites.

According to one aspect of the present invention, a system and methodology is provided through which users can access various features and functionality relative to travel and collaborative and informational aspects thereof. In a preferred embodiment, this functionality is accessed through a website available to users through various devices such as tablets, PCs, laptops, smartphones and other similar devices. Further, the system of the present invention includes interfaces and interoperability with other existing and to be developed websites and services such as Facebook, Twitter, LinkedIn, Pinterest and others so that activity occurring through one of these services can be shared with other services and the services of the present invention and vice versa.

According to another aspect of the present invention, the system compiles various attributes associated with the collective user trips and planned trips including, for example, locations, check-ins, photos, videos and blogs. This information may be manually provided by users or alternatively, some information may be automatically collected by the system based upon data captured and available through user devices such as GPS location data, stored photos and videos, blog entries and other data including reviews, travelogues, etc.

According to yet another aspect of the present invention, the system provides the ability for users to rate locations and attractions that they have visited and comment on them for the benefit of other users. This may include the uploading and presentment of photos and videos taken by the user which rates the attraction and/location including comments and tagging by keyword with respect to such photos and videos. This, in turn, results in the availability of a database of information, photographs, videos and other content which can be rapidly accessed by other users of the service based on their search for content relevant to them and their planned or ongoing trips and/or otherwise desired by them.

Another aspect of the system is the inclusion of a real time live status functionality with mapping for users of the service. In this way, and subject to users giving their permission to use data collected from them and their devices, users of the service can view a map, for example, and see where other users of the service are located at any point in time. Thus, users desiring to interact with one another via the service to discuss and share information concerning specific locations may do so through the service. Further, and subject to all parties giving the necessary authorization, the users may decide to meet in person at a specific location based upon similar travel interests, similar personal interests, being at or near the same attraction and/or other criteria as may be desirable.

Further features and aspects of the present invention will become apparent from the following detailed description of the exemplary embodiments in connection with reference to the attached FIGURE.

### BRIEF DESCRIPTION OF THE DRAWINGS

FIG. 1 is a diagram depicting the major components of the system of the present invention in a preferred embodiment thereof.

### DETAILED DESCRIPTION

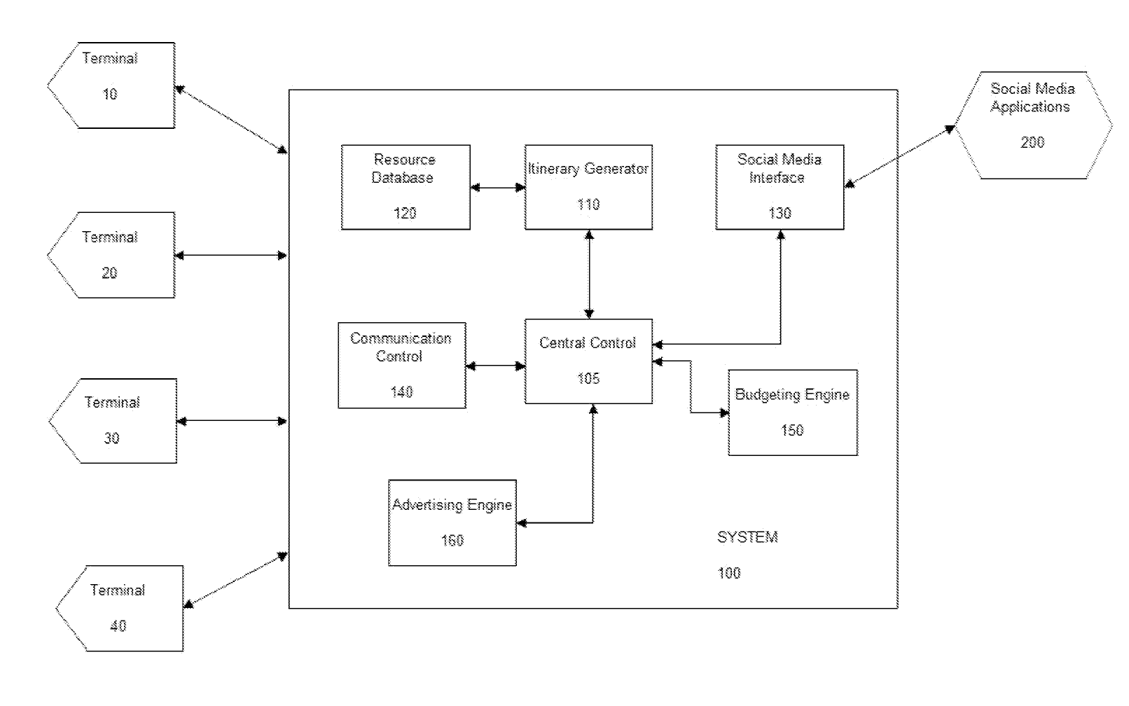

A description of the present invention in preferred embodiments thereof, now follows. With reference now to FIG. 1, the system of the present invention, in a preferred embodiment thereof, is now described. System 100 includes a number of components that implement the functionality and methodologies of the present invention in a preferred embodiment. It will be understood by one of skill in the art that the system and methodologies of the present invention are described herein in the form of a number of preferred embodiments and that it is possible to deviate from these specific embodiments while still remaining within the scope and spirit of the present invention.

System 100, in a preferred embodiment includes itinerary generator 110, resource database 120, social media interface 130, communication control functionality 140, budgeting engine 150 and advertising engine 160. A description for each of these components, including the specific functionality that they provide as well as how they relate to other system components, is provided in detail below.

System 100 interfaces with a number of terminals 10, 20, 30 and 40. In practice and in a preferred embodiment, these terminals may comprise any device capable of displaying, receiving and communicating information. For example, terminals may be smartphones, laptop computers, desktop computers, tablets, dedicated devices and/or other portable or fixed devices that may access the internet or other network either wirelessly or through a wired connection. In practice, there will likely be many more than four terminals interacting with system 100 at any given time and the four terminals are shown only for illustrative purposes.

System 100, in a preferred embodiment, is a server based application that provides website based functionality whereby users may access a dedicated website to obtain the services described herein. Further, system 100 may interface and communicate with various social media applications 200 as described herein. Exemplary social media applications include Facebook, Twitter, LinkedIn, Pinterest and others. The functionality of system 100 may, in one embodiment, be developed as an application residing within or in connection with one or more of these social media applications. In this manner, users can log into and obtain the services provided by system 100 though the use of account information associated with one or more of these social media applications. Alternatively, or in addition, users may access the services of the present invention via a native/dedicated account connected to the travel services provided by system 100.

Turning now to a description of the specific components of system 100 in a preferred embodiment thereof, itinerary generator 110 generates trip itineraries based on specific criteria as described more fully below. Further, itinerary generator 110 is able to generate a trip itinerary in real time or in near real time based on a traveler “checking in” during an actual trip. In either case, the content associated with the itinerary may be selectively shared with and accessed by other users of the service. In addition or alternatively to “checking in” during the actual trip, the traveler could provide some or all of the trip content after the trip has ended. It is thus possible for the traveler to construct the trip after returning home using content obtained during the trip (e.g. photos) and possibly combining it with additional content (e.g. descriptive text) created after the trip.

Resource database 120 contains content including photos, videos, links, and other information associated with travel. This information may be sourced from users who have taken trips, users who have planned trips, and from external sources and databases including as may be available through social media applications 200. This content is used by system 100 in generating trip itineraries as described in more detail below. Social media interface 130 manages and controls all interactions between system 100 and social media applications 200. Communication control 140 manages all communications between and among users of system 100. This may include chat, dedicated email and other forms of communication which allows users of system 100 to collaborate, communicate and share information regarding trips taken, trips planned and other travel related information.

Budgeting engine 150 provides functionality associated with trip itinerary generation based on a defined budget as described in more detail below. Finally, advertising engine 160 provides functionality which allows system 100 to capture, organize and leverage trip information to provide for targeted advertising opportunities. This aspect of system 100 is also described in further detail below.

One primary function of the system of the present invention is to provide enhanced blogging and logging capabilities. In addition, users can pre-create trip itineraries before taking a trip, or alternatively, automatically create a trip itinerary for later review and sharing by “checking-in” at various locations during the actual trip. According to a preferred embodiment of the present invention, users can use their smartphones, pc's, tablets or other devices to accomplish various actions related to trip planning as well as collaborating with other users regarding trip planning and in respect of travel related issues and content.

For example, users may communicate with system 100 to upload geo-tagged photos and videos. In addition, users may selectively highlight specific photos and videos that have been uploaded and provide content such as descriptive information with respect to these photos and videos. Users may also comment or blog about the location, photos and videos. This may include comment by either the user uploading the subject photos or videos or alternatively, by one or more other users of the service. It is also possible to segregate commentary by locating content associated with the uploaded photos and videos and which was provided by the user uploading the photo/video in one place while locating commentary from other users in another place when displayed.

Photos may also be color coded and classified in various other manners based on specific travel interests such as, for example, adventure, relaxing, standard travel, hotel, historic locations, etc. System 100 compiles the locations, check-ins, photos, videos, blogs and other content and makes this content easily viewable by other users at the request of these users. In one embodiment, system 100 allows users providing trip content to restrict viewing and/or the ability to associate content with the trip content to only specific users such as friends, family, travel agents, tour providers, or designated demographic groups such as females between the ages of 20 and 30.

The trip itinerary, as mentioned above, can be created and then formatted and generated by itinerary generator 110 either prior to a user taking a trip or in “real time” as the user is actually taking the trip. As mentioned above, it is also possible for some or all of the content to be provided after completion of the trip. In the case where the itinerary is created prior to taking the trip, itinerary generator 110 may access resource database 120 to obtain information helpful in trip planning and present it to the user for selection. For example, if a user desires to take a trip in the Washington, D.C. area, resource database 120 may present options for hotels, car rentals, tours, attractions, etc. in the DC area. The user may specify specific interests associated with the trip (for example Civil War related attractions) and system 100 can access resource database 120 as well as trip data resulting from trips taken or planned by other users and present those choices to the user for selection. For example, system 100, via itinerary generator 110, may present a proposed trip plan showing specific days and proposed travel and activities during those days. By way of example:
Day 1: Hyatt Hotel, 200 Main St, Washington D.C., Visit Civil War memorial museum, drive in the evening to Manassas, Va.
Day 2: Manassas Days Inn, 300 2^{nd} Avenue, Manassas, Va., visit civil war battlefield.
ETC.

Along with the proposed trip plan, reviews, photos, videos, proposed travel routes and other information relevant to the generated trip may be presented to the user to assist in trip planning. This information may be sourced from third party commercial sources (e.g. Frommers, Fodors, National Geographic etc.) and/or from content obtained from other users of system 100. By way of example, for the above proposed trip, system 100 may search for and make available to the user, photos of the Civil War memorial museum obtained from other users that have previously traveled to this attraction along with reviews to assist the user in trip planning.

The planned trip may be presented by system 100 to users in many different ways. In one preferred embodiment, the trip is presented on a map with color coded dots that expand into thumbnail photos of each of the photo locations. Clicking on the photo takes the follower to the photo album for that day or location. Alternatively, in another preferred embodiment, the trip is presented on a timeline wherein the trip activity is linear in time and relational from the beginning of the trip. Again, users may click on various days to see what is planned or what was accomplished on this day along with content relating to the same.

Alternatively or in addition, trip content may be presented in “timeline” fashion according to the chronological order of the trip. Both itineraries and travel logs/blogs as well as other travel related content can be presented in this fashion with either or both of the traveler or the view determining how the content should be presented. According to a preferred embodiment of the present invention, when presented in a “timeline” fashion, content, including various trip elements such as pictures, videos, descriptive text and URL hyperlinks , are displayed in chronological order and a user can interact with the various elements to obtain additional information as well as get a sense of how the trip is planned or how the trip was taken according to the relative time progression.

As mentioned above, itinerary generator 110 can also generate an itinerary based on actual user travel in “real time”. In this case, the user typically carries a portable device such as smartphone acting as a terminal (10-40) which communicates and is able to upload content such as pictures, video and descriptive information to system 100 during the actual trip. Thus, system 100 may obtain photos and videos tagged with location data (via GPS/cell tower triangulation, for example in the case of a smartphone) preferably via a single click or some other easy method via the user device. In one example, this may be accomplished via a designated application or “app” for the smartphone. In this way, with little to no requirement for user input, photos, for example, can be uploaded to system 100 and system 100 can automatically obtain location and time data as well as possibly some classification information such as trip type (e.g. adventure, scuba, relaxing). This information can be used to generate a trip itinerary for the user to later review and/or for other users to view either during or after the trip has been completed.

By way of example, if a user was about to embark on a scuba trip in the Cayman Islands, the user could set up parameters such as:
1) Trips to the Caribbean
2) Scuba Trips
3) Adventure Travel
   and these tags would automatically be applied to each photo/video/description uploaded during the trip. In addition, the device used by the user can automatically capture location and time data and all of this can be associated with the content uploaded by the user. The user and other users can then locate this trip by searching for these tags, for example, and then view this trip according to either a map view, a timeline view or other formats as may be desired.

In a preferred embodiment, users can log onto system 100 through other web based services and/or through a dedicated set of credentials for accessing system 100 and the services thus provided. For example, users may logon to system and authorization may occur via social media interface 130 as that component communicates with the relevant social media application(s) 200. Exemplary social media applications include Facebook, Twitter, LinkedIn, Pinterest and others. Content may be passed back and forth between system 100 and social media applications 200 under the control of social media interface 130. While on the road, users of system 100 may link to other websites such as Foursquare or Yelp for assistance with restaurant and dining suggestions. Further, users can rate locations and attractions and comment on them for the benefit of other users. Again, this information may be passed back and forth between system 100 and social media applications 200.

In another aspect of system 100, live status and locations of other users of system 100 may be tracked and reported to other users so that these users can connect and chat about the locations/attractions of interest to them. In one embodiment, location and status data may be shown via a map and may include, for example, an avatar or other indication of each user on the map by geographic location. In addition, planned trips may be compared and analyzed by system 100 such that overlaps in terms of time and location can be reported to users desiring to receive this information. In this way, users who will be at the same location at the same time as other users can be notified of the same and they may decide to meet in person or otherwise share information or communicate via system 100 at the time they are at the same location. All of this functionality is managed by communication control 140 which also preferably controls this information and user interaction according to the privacy settings and preferences of users. For example, some users may desire that their location not be reported and/or that they not receive communication from some or all other users.

These desires should be honored by system 100 under the control of communication control 140 and central control 105.

After a user completes a trip that he or she either planned before the trip, created via real time “check-ins”, created after the trip has taken place, or some combination of each, system 100 can generate for display or for hard copy printing a trip journal containing all relevant photos, videos and blog entries in a “Trip Journal” format. The user can also view a timeline video of the trip from the highlighted/selected photos and videos from different locations. The user can adjust this video to include or exclude elements (photos, videos, blogs) of the trip and also narrate over the video. In one embodiment, music to go with the video may be selected by the user or automatically determined/suggested by system 100 based on locations visited, attractions visited and/or other aspects of the trip as may be determined via tags associated with the trip (e.g. scuba, adventure, relaxing). For example, a trip to San Francisco may result in some or all of the following songs being suggested:
Dock of the Bay
I Left My Heart in San Francisco
California Dreamin'
California Girls
Goin' to California

As discussed above, the user can classify trips and activities with keywords or hash tags. Other users with like minded interests can view the trips of other users based on searching these keywords or tags for their own interests. If a user finds a trip of interest, in one embodiment, they can click on a button that says, for example, “Take This Trip” and the same itinerary can be built for this later user so that the later user can take the trip. The user can manually adjust this trip as desired, including, for example, swapping out attractions, choosing different hotels and reordering the locations visited. System 100, based on data available via resource database 120 and social media applications 200 as well as access to third party data, can automatically update trip elements based on the trip being taken at a later time than the original trip. This may include, for example, different hotel rates, different hours of operation for attractions, restaurants, etc.

As another aspect, users can create a “Bucket List” of locations which they desire to visit and store this information within a profile. When planning a trip, users will be able to choose locations from the bucket list and add them to their itinerary as applicable. System 100 will build the most efficient route for the itinerary and suggest hotels, activities and attractions. Additionally, system 100 can automatically display content including reviews, tips, blogs and photos and videos sourced from other users who have previously visited these locations.

In another preferred embodiment of the present invention, system 100 also includes budgeting engine 150. Users are able to generate a proposed budget for a trip along with desired locations and activities and system 100 will attempt to build an itinerary for the user within the desired budget. This can include suggested hotels, restaurants and activities based on available daily budget or overall trip budget.

In yet another aspect of the present invention, system 100 may also include advertising engine 160. This component stores trip information regarding trips planned and taken by users as well as components of these trips including which hotels, restaurants and attractions are visited or planned to be visited and how often as well as other transactional data associated with trips. This information is used by advertising engine to provide targeted advertising opportunities to users who have taken trips or are planning trips as well as users which have expressed an affinity for certain kinds of travel.

In a preferred embodiment, system 100 also tracks for all users, miles traveled, blog visitors and places visited along with other data regarding trips taken and planned by users. This information can be used by advertising engine 160 to further target advertising opportunities as well as to suggest specific trips, attractions and/or locations to users in a way that is most relevant to them.

System 100 may also function to allow users to copy some or all aspects of previously taken trips in the context of conferences or business trips. In this way, for example, conference planners can identify suitable venues for business meetings as well as get an idea of costs and reviews to assist in making decisions concerning conference planning.

System 100 could provide, in one embodiment, websites and applications as well as user experiences that are customized for each user based on interests. For example, users that travel by RV could have articles and content pushed to them which is relevant to RV travel. In addition, books, magazines and goods from partner and non-partner retailers could be suggested to these users based on interests.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. An online travel planning system configured to provide trip planning capabilities, the online travel planning system comprising:
one or more processors configured to execute computer program modules, the computer program modules comprising:
an itinerary generation module configured to receive content associated with one or more geographic locations from at least one terminal, wherein said at least one terminal is physically present at said one or more geographic locations at the time such content is provided by said at least one terminal, wherein said itinerary generation module processes said content to generate at least one trip plan indicative of said geographic locations visited and wherein said at least one trip plan includes such content; and
a trip plan access module configured to provide at least one user with access to view and/or modify said at least one trip plan.

2. The travel planning system of claim 1 wherein said content comprises photographs.

3. The travel planning system of claim 1 wherein said content comprises video.

4. The travel planning system of claim 1 wherein said travel planning system interfaces with at least one social media platform for sharing said content.

5. The travel planning system of claim 1 wherein said travel planning system interfaces with at least one social media platform for sharing said at least one trip plan.

6. The travel planning system of claim 1 further comprising a budgeting module configured to generate at least one trip plan that conforms to budgeting constraints provided by a user.

7. The travel planning system of claim 1 further comprising a searching module configured to permit one or more users to search multiple trip plans by keyword, location or tags.

8. The travel planning system of claim 1 further comprising a user notification module configured to notify a user that has a trip plan which is indicative of said user's intention to generally coincide in time and location with that of another user as indicated by said another user's trip plan.

9. The travel planning system of claim 8 further comprising a user communication module configured to permit communication and interaction between multiple users with trip plans that generally coincide in at least one time and location pairing.

10. A computer-implemented method for trip planning comprising the steps of:
receiving content associated with one or more geographic locations from at least one terminal, wherein said at least one terminal is physically present at said one or more geographic locations at the time such content is provided by said at least one terminal;
processing said content to generate at least one trip plan indicative of said geographic locations visited and wherein said at least one trip plan includes such content; and
providing access to at least one user to view and/or modify said at least one trip plan.

11. The computer-implemented method of claim 10 further comprising the step of step of interfacing with at least one social media platform for sharing said content.

12. The computer-implemented method of claim 10 further comprising the step of interfacing with at least one social media platform for sharing said at least one trip plan.

13. The computer-implemented method of claim 10 wherein said at least one trip plan conforms to budgeting constraints provided by a user.

14. The computer-implemented method of claim 10 further comprising the step of enabling one or more users to search multiple trip plans by keyword, location or tags.

15. The computer-implemented method of claim 10 further comprising the step of notifying a user that has a trip plan which is indicative of said user's intention to generally coincide in time and location with that of another user as indicated by said another user's trip plan.

16. The computer-implemented method of claim 15 further comprising the step of enabling communication and interaction between multiple users with trip plans that generally coincide in at least one time and location pairing.

17. A travel related advertising system configured to provide travel related advertising to users, the advertising system comprising:
one or more processors configured to execute computer program modules, the computer program modules comprising:
an advertising generation module configured to receive trip information regarding trips taken or planned by said users and to determine advertising placements relevant to said users based upon said trip information; and
an advertising presentation module configured to display said advertising placements to said users.

18. The advertising system of claim 17 wherein said trip information includes geographic locations travelled to or planned to be travelled to by said users.

19. The advertising system of claim 17 wherein said advertising placements comprise suggested trips, suggested attractions or suggested locations based upon said trip information.

20. The advertising system of claim 17 wherein said advertising placements comprise suggested hotels.
